(19) United States
(12) Patent Application Publication
(10) Pub. No.: US 2026/0011958 A1
(43) Pub. Date: Jan. 8, 2026

(54) Signal Transmission Element Assembly and Electrical Connector Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/239,316

(22) Filed: Jun. 16, 2025

(30) Foreign Application Priority Data
Jul. 5, 2024 (TW) 113207302

(51) Int. Cl. H01R 13/6581

(52) U.S. Cl. CPC H01R 13/6581

(57) ABSTRACT

A signal transmission element assembly and electrical connector thereof, wherein the electrical connector is assembled and formed by a plurality of conductive terminal modules. Therefore, even after the design of the electrical connector is completed, it is still possible to achieve customizable adjustment of the quantity and structure of the conductive terminals of the electrical connector by adjusting the assembled plurality of conductive terminal modules, thereby meeting the requirements of electronic devices for signal transmission. Additionally, the electrical connector is provided with a metal shielding wall, which is configured to provide shielding between the plurality of conductive terminals used for signal transmission, thereby reducing the degree of interference experienced by the electrical connector during signal transmission and further satisfying the requirements of electronic devices for high-speed signal transmission.

### CROSS-REFERENCE TO RELATED APPLICATIONS

This application claims the priority of Republic of China Patent Application No. 113207302 filed on Jul. 5, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more specifically, to a signal transmission element assembly and its electrical connector, which allow for the customizable adjustment of the quantity and structure of conductive terminals and can reduce signal interference.

### Descriptions of the Related Art

In recent years, electrical connectors have been widely applied to various electronic devices to transmit signals via multiple conductive terminals. To meet the specific needs and developments of electronic devices, the quantity and structure of conductive terminals in electrical connectors are often required to be customizable. However, in current designs, once an electrical connector is finalized, the quantity and structure of its conductive terminals are fixed and cannot be customized, making it difficult to satisfy the signal transmission requirements of electronic devices. Consequently, this limitation restricts the technological (functional) development of electronic devices.

Furthermore, there may also be a demand for transmitting high-speed signals via the multiple conductive terminals of electrical connectors. Currently, electrical connectors are prone to interference when transmitting high-speed signals. Such interference may include electromagnetic interference from external environments or crosstalk coupling between multiple conductive terminals within the electrical connector, which can lead to signal attenuation and interference during high-speed signal transmission.

Therefore, as described above, it is an urgent problem in the relevant technical field to achieve customizable adjustment of the quantity and structure of conductive terminals in electrical connectors and to address the issue of interference during high-speed signal transmission.

### SUMMARY OF THE INVENTION

In view of the drawbacks of the prior art mentioned above, the present application provides an electrical connector, comprising: a major conductive terminal module, the major conductive terminal module comprising a major conductive terminal set, a major conductive plastic bridging base, and a major insulation plastic mating base, wherein the major conductive terminal set comprises a first major bridging conductive terminal, a second major bridging conductive terminal, and a major non-bridging conductive terminal; the major conductive plastic bridging base spans the major non-bridging conductive terminal and electrically connects the first major bridging conductive terminal and the second major bridging conductive terminal, and the major insulation plastic mating base mates the major conductive terminal set and the major conductive plastic bridging base to form a major conductive terminal module mating component; a minor conductive terminal module, the minor conductive terminal module comprising a minor conductive terminal set, a minor conductive plastic bridging base, and a minor insulation plastic mating base, wherein the minor conductive terminal set comprises a first minor bridging conductive terminal, a second minor bridging conductive terminal, and a minor non-bridging conductive terminal, and the minor conductive plastic bridging base spans the minor non-bridging conductive terminal and electrically connects the first minor bridging conductive terminal and the second minor bridging conductive terminal, and the minor insulation plastic mating base mates the minor conductive terminal set and the minor conductive plastic bridging base to form a minor conductive terminal module mating component; a metal shielding module, the metal shielding module comprising a major metal shielding wall, a minor metal shielding wall, and a metal shielding connecting body, wherein the metal shielding connecting body connects the major metal shielding wall and the minor metal shielding wall to form a metal shielding component, such that the major metal shielding wall and the minor metal shielding wall are electrically connected; and an electrical connector insulation core, the electrical connector insulation core comprising an electrical connector insulation core support structure, wherein the electrical connector insulation core assembles the major conductive terminal module mating component, the minor conductive terminal module mating component, and the metal shielding component, and the electrical connector insulation core support structure provides support to the metal shielding component, enabling the major metal shielding wall to electrically connect with the major conductive plastic bridging base, and enabling the minor metal shielding wall to electrically connect with the minor conductive plastic bridging base, respectively so as to transmit shielding signals; and the major metal shielding wall extends along the side of the major conductive terminal set to provide shielding for the major conductive terminal set, and the minor metal shielding wall extends along the minor conductive terminal set to provide shielding for and the minor conductive terminal set.

Preferably, the electrical connector said above, wherein the major conductive plastic bridging base comprises a first major conductive plastic bridging base clamping structure and a second major conductive plastic bridging base clamping structure, the first major conductive plastic bridging base clamping structure clamps and positions the first major bridging conductive terminal, and the second major conductive plastic bridging base clamping structure clamps and positions the second major bridging conductive terminal; and the minor conductive plastic bridging base comprises a first minor conductive plastic bridging base clamping structure and a second minor conductive plastic bridging base clamping structure, the first minor conductive plastic bridging base clamping structure clamps and positions the first minor bridging conductive terminal, and the second minor conductive plastic bridging base clamping structure clamps and positions the second minor bridging conductive terminal.

Preferably, the electrical connector said above, wherein the metal shielding component is a U-shaped structure disposed across the electrical connector insulation core support structure.

Preferably, the electrical connector said above, wherein the electrical connector insulation core assembles the major conductive terminal module mating component, the minor conductive terminal module mating component, and the metal shielding component in an assembling direction.

Preferably, the electrical connector said above, wherein the metal shielding component comprises a metal shielding component assembling channel and a metal shielding component assembling space, the electrical connector insulation core support structure is capable of entering the metal shielding component assembling space via the metal shielding component assembling channel in the assembling direction.

Preferably, the electrical connector said above, wherein the major metal shielding wall and the minor metal shielding wall are laterally positioned within the metal shielding component assembling space, and the electrical connector insulation core support structure provides lateral support to the major metal shielding wall and the minor metal shielding wall; and the metal shielding connecting body is longitudinally positioned within the metal shielding component assembling space, and the electrical connector insulation core support structure provides longitudinal support to the metal shielding connecting body.

Preferably, the electrical connector said above, wherein the major conductive plastic bridging base comprises a major conductive plastic bridging base abutting structure, wherein, in the major conductive terminal module mating component, the major conductive plastic bridging base abutting structure is exposed from the major insulation plastic mating base to abut the major metal shielding wall; and the minor conductive plastic bridging base comprises a minor conductive plastic bridging base abutting structure, wherein, in the minor conductive terminal module mating component, the minor conductive plastic bridging base abutting structure is exposed from the minor insulation plastic mating base to abut the minor metal shielding wall.

Preferably, the electrical connector said above, wherein the major metal shielding wall comprises a major metal shielding wall protrusion structure, and the major metal shielding wall protrusion structure provides abutting for the major conductive plastic bridging base; and the minor metal shielding wall comprises a minor metal shielding wall protrusion structure, the minor metal shielding wall protrusion structure provides abutting for t the minor conductive plastic bridging base.

Furthermore, the present application also provides a signal transmission element assembly, comprising: a signal transmission extension material; and an electrical connector, wherein the electrical connector comprises: an electrical connector, wherein the electrical connector comprises: a major conductive terminal module, which comprises a major conductive terminal set, a major conductive plastic bridging base, and a major insulation plastic connecting base, wherein the major conductive terminal set comprises a first major bridging conductive terminal, a second major bridging conductive terminal, and a major non-bridging conductive terminal, the major conductive plastic bridging base spans across the major non-bridging conductive terminal and electrically connects the first major bridging conductive terminal and the second major bridging conductive terminal, and the major insulation plastic connecting base joins the major conductive terminal set and the major conductive plastic bridging base to form a major conductive terminal module connecting component; a minor conductive terminal module, which comprises a minor conductive terminal set, a minor conductive plastic bridging base, and a minor insulation plastic connecting base, wherein the minor conductive terminal set comprises a first minor bridging conductive terminal, a second minor bridging conductive terminal, and a minor non-bridging conductive terminal, the minor conductive plastic bridging base spans across the minor non-bridging conductive terminal and electrically connects the first minor bridging conductive terminal and the second minor bridging conductive terminal, and the minor insulation plastic connecting base joins the minor conductive terminal set and the minor conductive plastic bridging base to form a minor conductive terminal module connecting component; a metal shielding module, which comprises a major metal shielding wall, a minor metal shielding wall, and a metal shielding connecting body, wherein the metal shielding connecting body joins the major metal shielding wall and the minor metal shielding wall to form a metal shielding component, enabling the major metal shielding wall and the minor metal shielding wall to be electrically connected; and an electrical connector insulation core, which comprises an electrical connector insulation core support structure and an electrical connector insulation core joining port, wherein the electrical connector insulation core assembles the major conductive terminal module connecting component, the minor conductive terminal module connecting component, and the metal shielding component, enabling the major conductive terminal set and the minor conductive terminal set to respectively extend to the electrical connector insulation core joining port to provide joining with the signal transmission extension material for signal transmission, and the electrical connector insulation core support structure provides support to the metal shielding component, enabling the major metal shielding wall to be electrically connected to the major conductive plastic bridging base, and enabling the minor metal shielding wall to be electrically connected to the minor conductive plastic bridging base so as to transmit shielding signals, and the major metal shielding wall extends along the side of the major conductive terminal set, and the minor metal shielding wall extends along the side of the minor conductive terminal set, thereby respectively providing shielding for the major conductive terminal set and the minor conductive terminal set.

Preferably, the signal transmission element assembly said above, wherein the signal transmission extension material is a circuit board material, a conductive wire material, or an inserting board material.

Compared to the prior art, the present application provides a signal transmission element assembly and electrical connector thereof, wherein the electrical connector is at least assembled from an electrical connector insulation core, a metal shielding wall, and multiple conductive terminal modules. The electrical connector insulation core is capable of providing support to the metal shielding wall, allowing the metal shielding wall to extend along the sides of the multiple conductive terminal modules and provide shielding for the multiple conductive terminal modules, thereby reducing the degree of interference experienced by the electrical connector during signal transmission and meeting the requirements of electronic devices for high-speed signal transmission. Additionally, the multiple conductive terminal modules allow for the respective adjustment of the number and structure of the conductive terminals. Therefore, after the design of the electrical connector is completed, it is still possible to achieve customized adjustments to the number and structure of the conductive terminals of the electrical connector by adjusting the assembled multiple conductive terminal modules, thereby meeting the requirements of electronic devices for signal transmission.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic view of the signal transmission element assembly of the present application from a first perspective in one embodiment.

FIG. 2 is a three-dimensional schematic view of the signal transmission element assembly of the present application from a second perspective in one embodiment.

FIG. 3 is a front view schematic of the signal transmission element assembly of the present application in one embodiment.

FIG. 4 is a sectional schematic view along line AA of a portion of the signal transmission element assembly shown in FIG. 3.

FIG. 5 is a sectional schematic view along line BB of a portion of the signal transmission element assembly shown in FIG. 3.

FIG. 6 is a rear view schematic of the signal transmission element assembly of the present application in one embodiment.

FIG. 7 is a three-dimensional schematic view of the signal transmission element assembly of the present application from a first perspective in one embodiment.

FIG. 8 is a three-dimensional schematic view of the signal transmission element assembly of the present application from a second perspective in one embodiment.

FIG. 9 is a three-dimensional schematic view of a portion of the signal transmission element assembly of the present application in one embodiment.

FIG. 10 is a three-dimensional schematic view of a portion of the signal transmission element assembly of the present application in one embodiment.

FIG. 11 is a three-dimensional schematic view of a portion of the signal transmission element assembly of the present application in one embodiment.

FIG. 12 is a three-dimensional schematic view of the major conductive terminal module of the present application in one embodiment.

FIG. 13 is a three-dimensional schematic view of the minor conductive terminal module of the present application in one embodiment.

FIG. 14 is a three-dimensional schematic view of a portion of the signal transmission element assembly of the present application from a first perspective in one embodiment.

FIG. 15 is a three-dimensional schematic view of a portion of the signal transmission element assembly of the present application from a first perspective in one embodiment.

FIG. 16 is a sectional schematic view of the signal transmission element assembly of the present application in one embodiment.

FIG. 17 is a sectional schematic view of the signal transmission element assembly of the present application in one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

This application provides a signal transmission element assembly and electrical connector thereof, wherein the electrical connector is assembled from multiple conductive terminal modules. Therefore, after the design of the electrical connector is completed, the number and structure of the conductive terminals of the electrical connector can still be customized by adjusting the multiple assembled conductive terminal modules to meet the requirements of electronic devices for signal transmission. Additionally, the electrical connector comprises a metal shielding wall, which can provide shielding between the multiple conductive terminals used for signal transmission, thereby reducing the degree of interference during signal transmission and meeting the requirements of electronic devices for high-speed signal transmission.

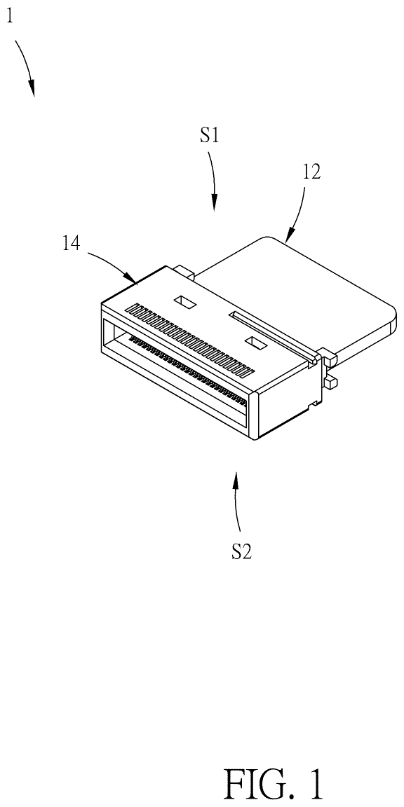

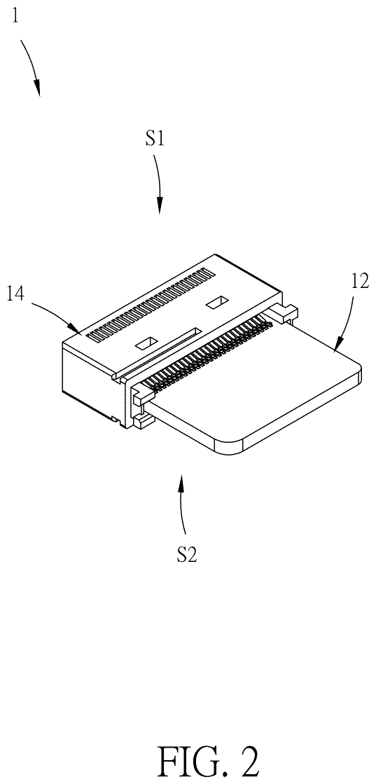

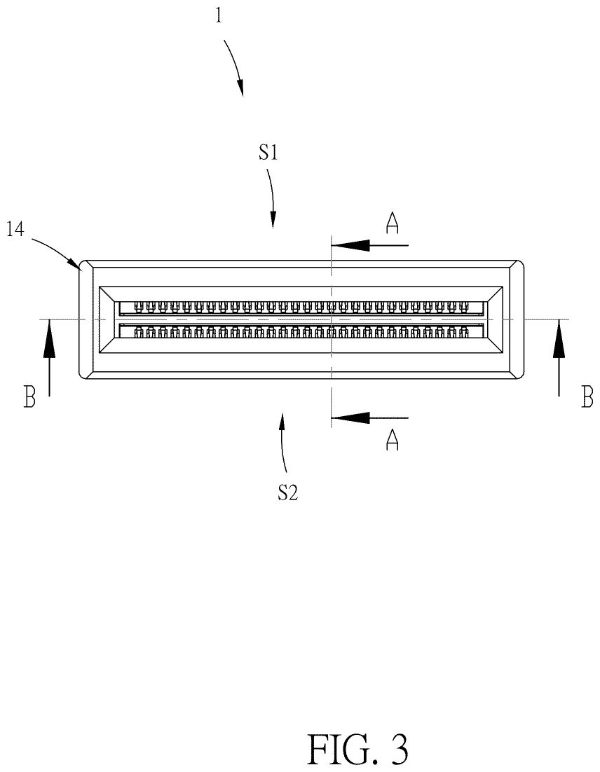

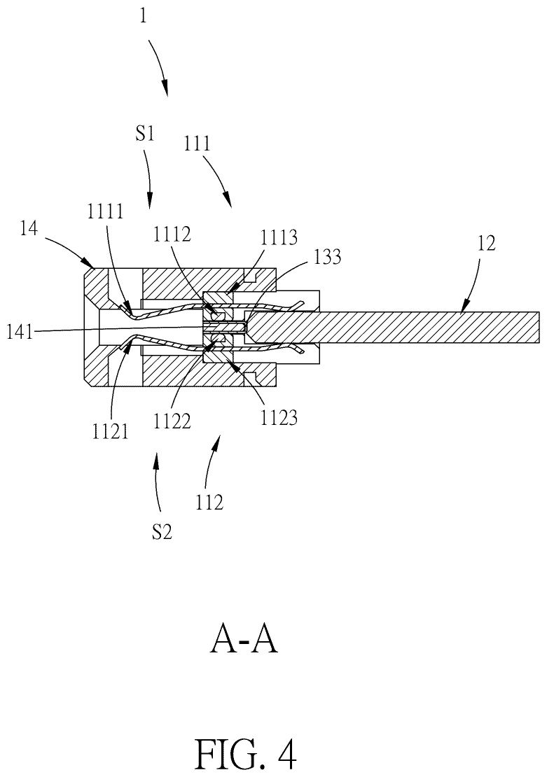

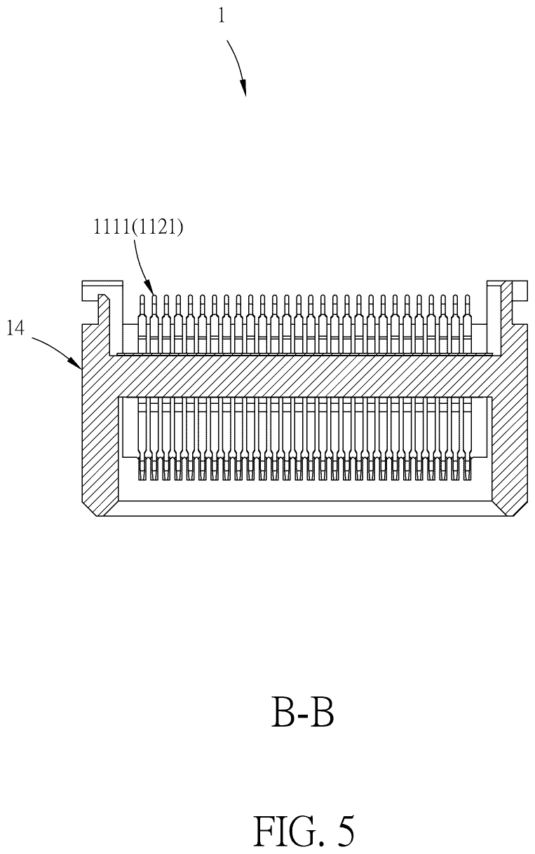

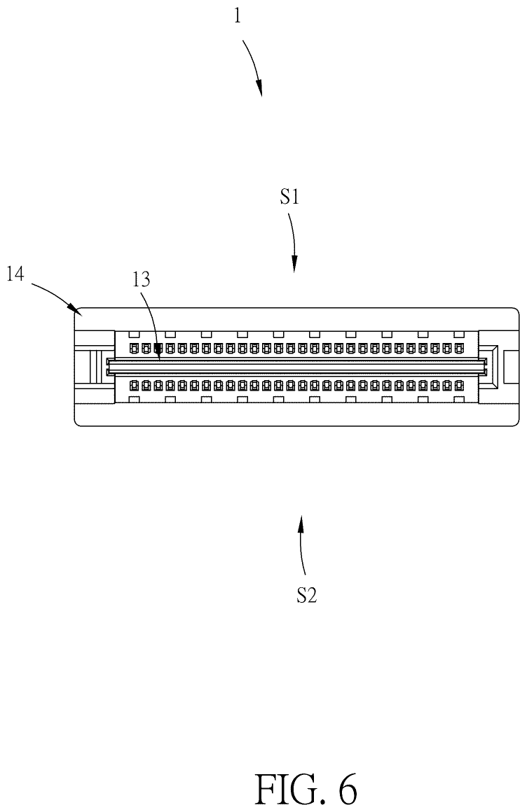

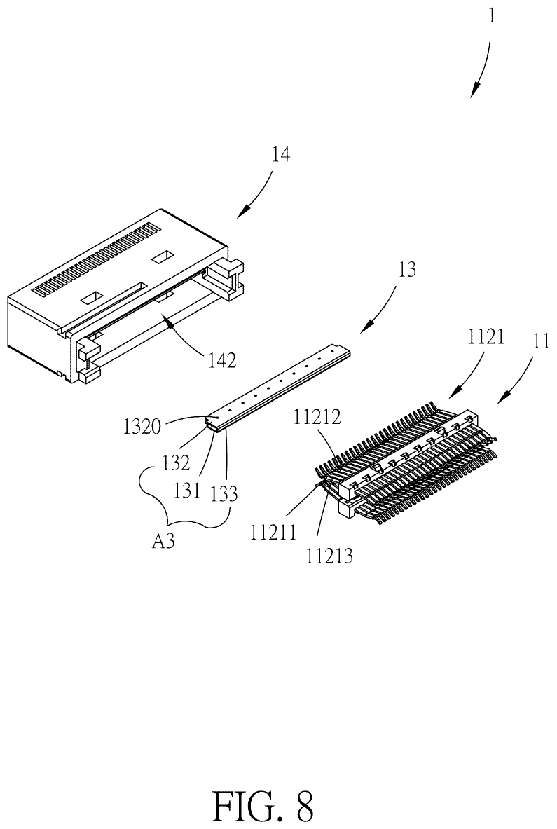

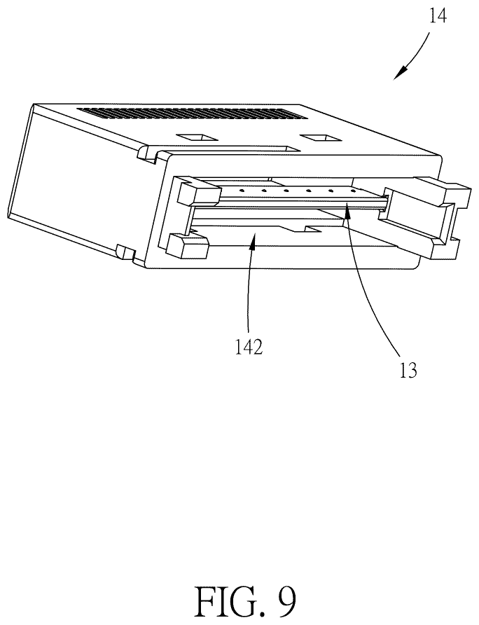

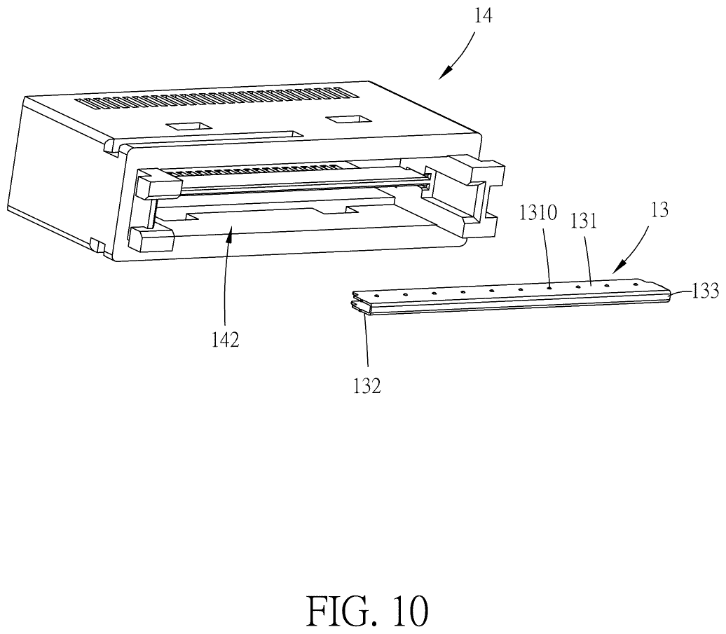

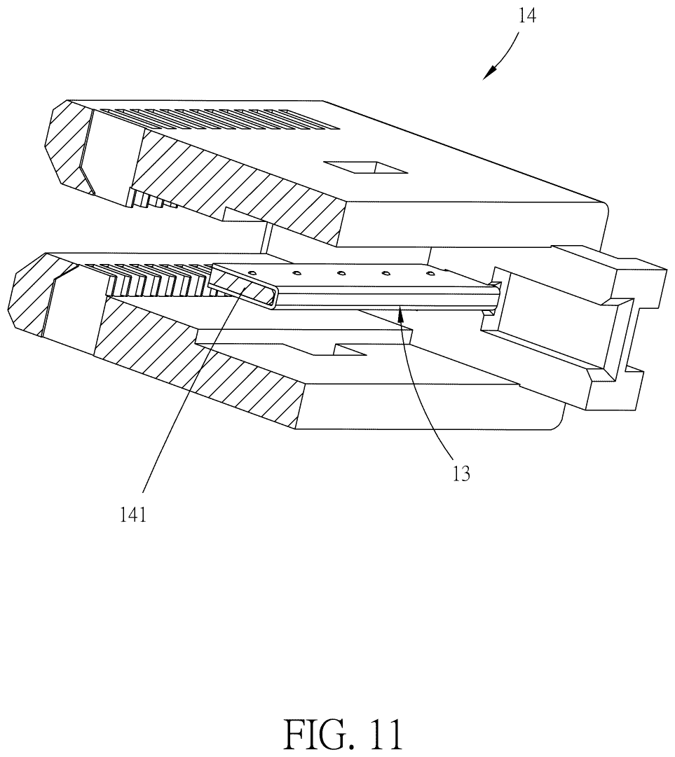

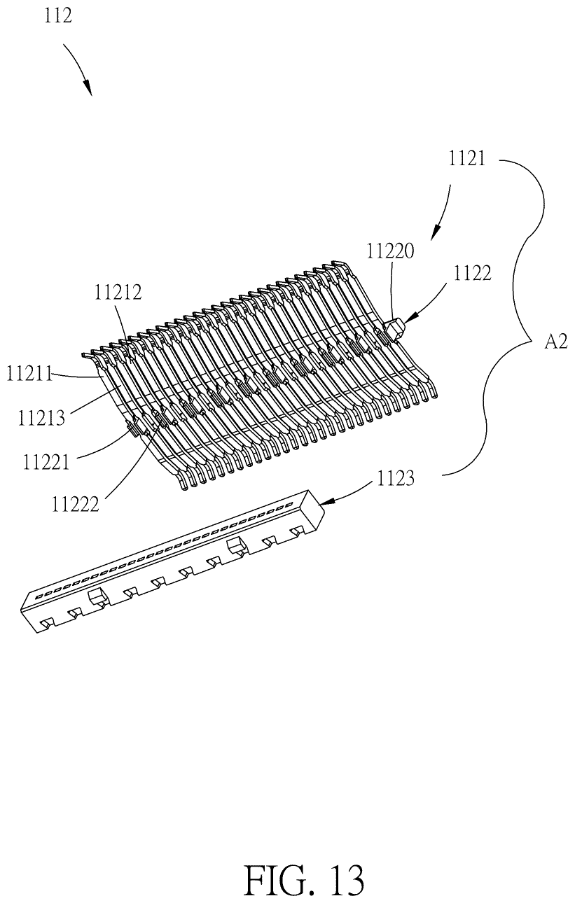

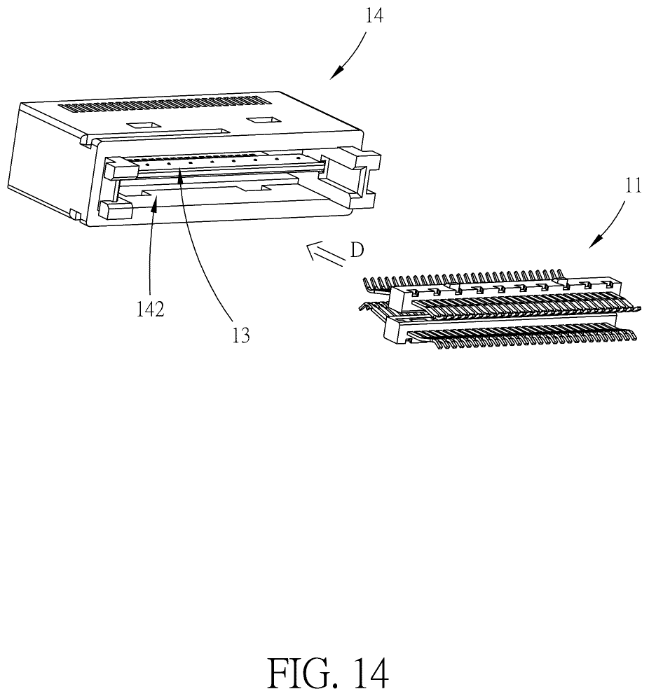

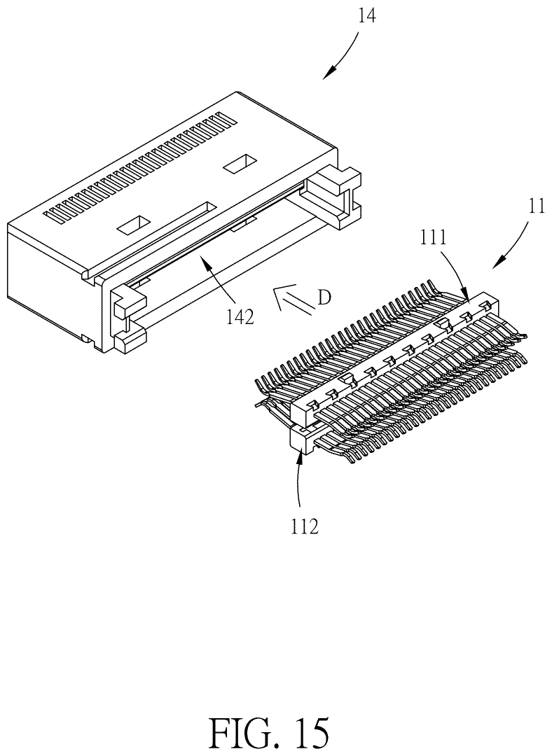

Regarding the technical concept of the electrical connector of this application, please refer to the embodiments illustrated in FIGS. 1 to 17.

In the embodiments shown in FIGS. 1 to 17, at least one signal transmission element assembly 1 is disclosed. The signal transmission element assembly 1 comprises: a signal transmission extension material 12 and an electrical connector 11. The two sides of the electrical connector 11 are respectively an electrical connector major side S1 and an electrical connector minor side S2. The electrical connector 11 comprises a major conductive terminal module 111, a minor conductive terminal module 112, a metal shielding module 13, and an electrical connector insulation core 14.

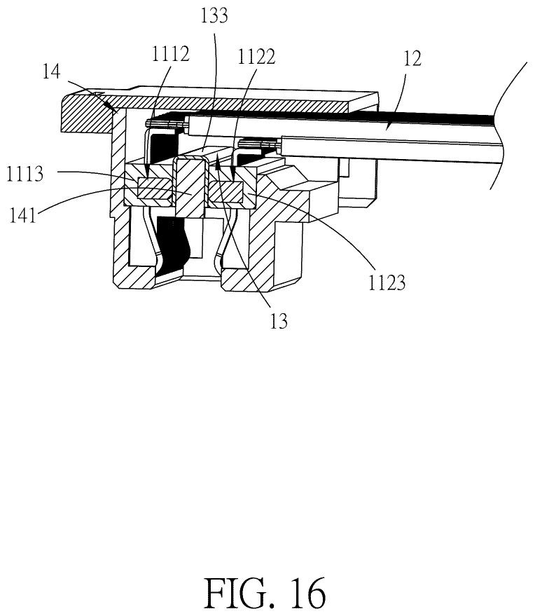

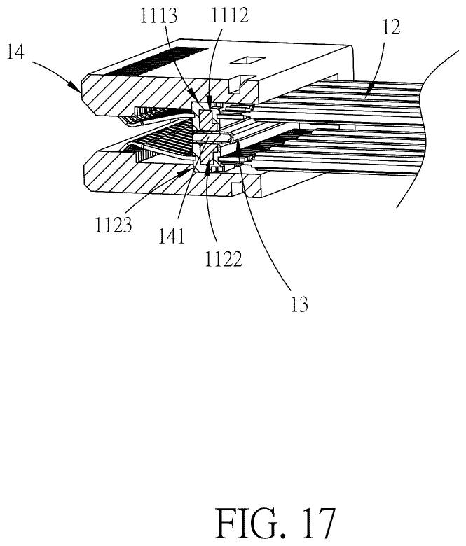

Regarding the signal transmission extension material 12, the signal transmission extension material 12 can provide an extended signal transmission length. For example, the signal transmission extension material 12 may be a circuit board material (not shown in figures), a conductive wire material (as shown in FIGS. 16 to 17), or an inserting board material (as shown in FIGS. 1 to 2 and FIG. 4).

Regarding the major conductive terminal module 111, the major conductive terminal module 111 comprises a major conductive terminal set 1111, a major conductive plastic bridging base 1112, and a major insulation plastic mating base 1113. In the above embodiments, the major conductive terminal set 1111 comprises a first major bridging conductive terminal 11111, a second major bridging conductive terminal 11112, and a major non-bridging conductive terminal 11113. The major conductive plastic bridging base 1112 comprises a first major conductive plastic bridging base clamping structure 11121 and a second major conductive plastic bridging base clamping structure 11122. The major conductive plastic bridging base 1112 bridges over the major non-bridging conductive terminal 11113, and the first major conductive plastic bridging base clamping structure 11121 clamps and positions the first major bridging conductive terminal 11111, and the second major conductive plastic bridging base clamping structure 11122 clamps and positions the second major bridging conductive terminal 11112, allowing the major conductive plastic bridging base 1112 to electrically connect the first major bridging conductive terminal 11111 and the second major bridging conductive terminal 11112. Additionally, the major insulation plastic mating base 1113 engages and positions the major conductive terminal set 1111 and the major conductive plastic bridging base 1112, forming a major conductive terminal module connecting component A1 with the major insulation plastic mating base 1113, the major conductive terminal set 1111, and the major conductive plastic bridging base 1112.

It should be noted that the first major bridging conductive terminal 11111 and the second major bridging conductive terminal 11112 can provide transmission of grounding signals, and the number of the first major bridging conductive terminal 11111 and the second major bridging conductive terminal 11112 is not limited to one (i.e., the number of the first major bridging conductive terminal 11111 and the second major bridging conductive terminal 11112 can be selected as multiple). Furthermore, the major non-bridging conductive terminal 11113 can provide transmission of non-grounded signals, such as differential signals, and the number of the major non-bridging conductive terminal 11113 is not limited to one (i.e., the number of the major non-bridging conductive terminal 11113 can be selected as multiple).

Regarding the minor conductive terminal module 112, the minor conductive terminal module 112 comprises a minor conductive terminal set 1121, a minor conductive plastic bridging base 1122, and a minor insulation plastic mating base 1123. In the above embodiments, the minor conductive terminal set 1121 comprises a first minor bridging conductive terminal 11211, a second minor bridging conductive terminal 11212, and a minor non-bridging conductive terminal 11213. The minor conductive plastic bridging base 1122 comprises a first minor conductive plastic bridging base clamping structure 11221 and a second minor conductive plastic bridging base clamping structure 11222. The minor conductive plastic bridging base 1122 bridges over the minor non-bridging conductive terminal 11213, and the first minor conductive plastic bridging base clamping structure 11221 clamps and positions the first minor bridging conductive terminal 11211, and the second minor conductive plastic bridging base clamping structure 11222 clamps and positions the second minor bridging conductive terminal 11212, allowing the minor conductive plastic bridging base 1122 to electrically connect the first minor bridging conductive terminal 11211 and the second minor bridging conductive terminal 11212. Additionally, the minor insulation plastic mating base 1123 engages and positions the minor conductive terminal set 1121 and the minor conductive plastic bridging base 1122, forming a minor conductive terminal module connecting component A2 with the minor insulation plastic mating base 1123, the minor conductive terminal set 1121, and the minor conductive plastic bridging base 1122.

It should be noted that the first minor bridging conductive terminal 11211 and the second minor bridging conductive terminal 11212 can provide transmission of grounding signals, and the number of the first minor bridging conductive terminal 11211 and the second minor bridging conductive terminal 11212 is not limited to one (i.e., the number of the first minor bridging conductive terminal 11211 and the second minor bridging conductive terminal 11212 can be selected as multiple). Furthermore, the minor non-bridging conductive terminal 11213 can provide transmission of non-grounded signals, such as differential signals, and the number of the minor non-bridging conductive terminal 11213 is not limited to one (i.e., the number of the minor non-bridging conductive terminal 11213 can be selected as multiple).

Regarding the metal shielding module 13, the metal shielding module 13 comprises a major metal shielding wall 131, a minor metal shielding wall 132, and a metal shielding connecting body 133. In the above embodiments, the metal shielding connecting body 133 electrically connects the major metal shielding wall 131 and the minor metal shielding wall 132, allowing the major metal shielding wall 131 and the minor metal shielding wall 132 to be electrically connected. The metal shielding connecting body 133, the major metal shielding wall 131, and the minor metal shielding wall 132 form a metal shielding component A3, wherein the metal shielding component A3 can transmit shielding signals, such as grounding signals.

Regarding the electrical connector insulation core 14, the electrical connector insulation core 14 comprises an electrical connector insulation core support structure 141 and an electrical connector insulation core overlap port 142. In the aforementioned embodiment, the electrical connector insulation core 14 can be assembled in an assembling direction D to integrate the major conductive terminal module connecting component A1, the minor conductive terminal module connecting component A2, and the metal shielding component A3, so that the major conductive terminal set 1111 can be located at the electrical connector major side S1, and the minor conductive terminal set 1121 can be located at the electrical connector minor side S2. The major conductive terminal set 1111 and the minor conductive terminal set 1121 can respectively extend to the electrical connector insulation core overlap port 142 to provide connection to the signal transmission extension material 12 for signal transmission. The electrical connector insulation core support structure 141 provides support for the metal shielding component A3, ensuring the major metal shielding wall 131 is electrically connected to the major conductive plastic bridging base 1112, and the minor metal shielding wall 132 is electrically connected to the minor conductive plastic bridging base 1122 to transmit shielding signals such as grounding signals. Furthermore, the major metal shielding wall 131 and the minor metal shielding wall 132 extend along the sides of the major conductive terminal set 1111 and the minor conductive terminal set 1121. Thus, the metal shielding component A3 is positioned between the major conductive terminal set 1111 and the minor conductive terminal set 1121, providing shielding for both terminal sets, thereby offering an electrically shielded environment for signal transmission between the major conductive terminal set 1111 and the minor conductive terminal set 1121. This reduces interference during high-speed signal transmission, optimizes the electrical connector 11 for high-speed signal transmission quality, and ensures compliance with the signal transmission requirements of electronic devices, meeting the specialized needs and development of electronic devices.

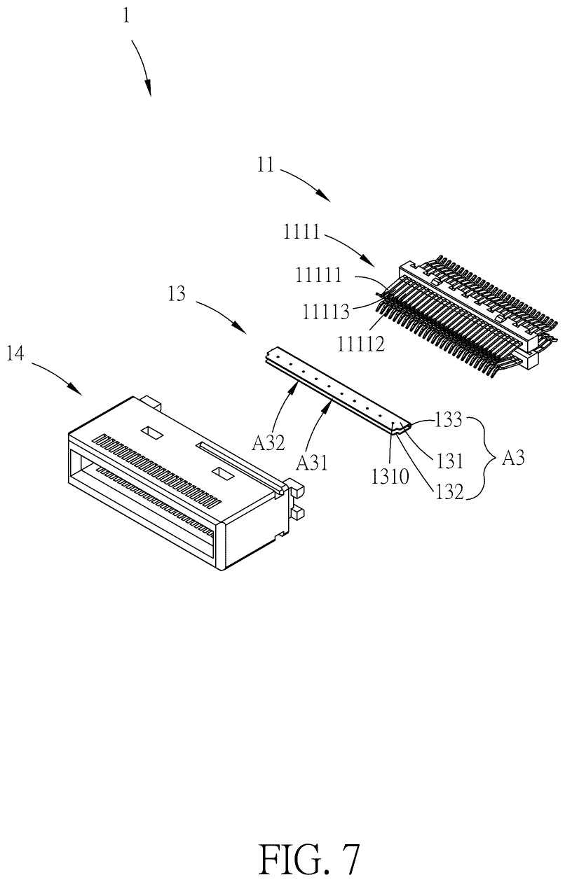

In the embodiment shown in FIG. 7, the metal shielding component A3 comprises a metal shielding component assembling channel A31 and a metal shielding component assembling space A32. Correspondingly, the major metal shielding wall 131 and the minor metal shielding wall 132 are positioned laterally in the metal shielding component assembling space A32. The metal shielding connecting body 133 is positioned longitudinally in the metal shielding component assembling space A32. Hence, the metal shielding component A3 forms a U-shaped structure spanning the electrical connector insulation core support structure 141. It should be noted that the electrical connector insulation core support structure 141 can enter the metal shielding component assembling space A32 via the metal shielding component assembling channel A31 in the assembling direction D, thereby providing lateral support to the major metal shielding wall 131 and the minor metal shielding wall 132, and longitudinal support to the metal shielding connecting body 133.

The major metal shielding wall 131 and the minor metal shielding wall 132 are laterally positioned in the metal shielding component assembling space A32, with the electrical connector insulation core support structure 141 providing lateral support to the major metal shielding wall 131 and the minor metal shielding wall 132, respectively. Additionally, the metal shielding connecting body 133 is longitudinally positioned in the metal shielding component assembling space A32, and the electrical connector insulation core support structure 141 provides longitudinal support to the metal shielding connecting body 133.

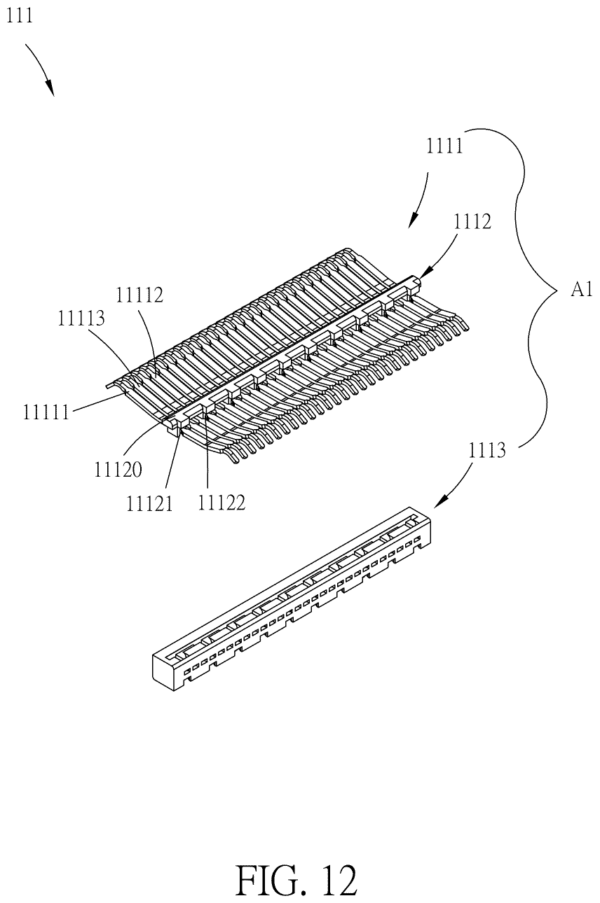

In the embodiment shown in FIG. 12, the major conductive plastic bridging base 1112 comprises a major conductive plastic bridging base abutting structure 11120. In the major conductive terminal module connecting component A1, the major conductive plastic bridging base abutting structure 11120 is exposed from the major insulation plastic connecting base 1113 to provide abutment to the major metal shielding wall 131. Correspondingly, the major metal shielding wall 131 comprises a major metal shielding wall protrusion structure 1310, which provides abutment to the major conductive plastic bridging base 1112, thereby ensuring electrical connection between the major metal shielding wall 131 and the major conductive plastic bridging base 1112.

Similarly, the minor conductive plastic bridging base 1122 comprises a minor conductive plastic bridging base abutting structure 11220. In the minor conductive terminal module connecting component A2, the minor conductive plastic bridging base abutting structure 11220 is exposed from the minor insulation plastic connecting base 1123 to provide abutment to the minor metal shielding wall 132. Correspondingly, the minor metal shielding wall 132 comprises a minor metal shielding wall protrusion structure 1320, which provides abutment to the minor conductive plastic bridging base 1122, thereby ensuring electrical connection between the minor metal shielding wall 132 and the minor conductive plastic bridging base 1122.

In the aforementioned embodiment, the electrical connector 11 comprises the major conductive terminal module 111 and the minor conductive terminal module 112. The major conductive terminal module 111 and the minor conductive terminal module 112 allow adjustments to the number and structure of conductive terminals, enabling customization of the electrical connector 11 to meet the signal transmission requirements of electronic devices.

It should be noted that in the aforementioned embodiments, certain components can be omitted. For example, in the present application, the electrical connector may optionally include: a major conductive terminal module, a minor conductive terminal module, a metal shielding module, and an electrical connector insulation core. The major conductive terminal module comprises a major conductive terminal set, a major conductive plastic bridging base, and a major insulation plastic connecting base, wherein the major conductive terminal set comprises a first major bridging conductive terminal, a second major bridging conductive terminal, and a major non-bridging conductive terminal. The major conductive plastic bridging base bridges across the major non-bridging conductive terminal and electrically connects the first major bridging conductive terminal and the second major bridging conductive terminal. The major insulation plastic connecting base joins the major conductive terminal set and the major conductive plastic bridging base to form a major conductive terminal module connecting component. The minor conductive terminal module comprises a minor conductive terminal set, a minor conductive plastic bridging base, and a minor insulation plastic connecting base, wherein the minor conductive terminal set comprises a first minor bridging conductive terminal, a second minor bridging conductive terminal, and a minor non-bridging conductive terminal. The minor conductive plastic bridging base bridges across the minor non-bridging conductive terminal and electrically connects the first minor bridging conductive terminal and the second minor bridging conductive terminal. The minor insulation plastic connecting base joins the minor conductive terminal set and the minor conductive plastic bridging base to form a minor conductive terminal module connecting component. The metal shielding module comprises a major metal shielding wall, a minor metal shielding wall, and a metal shielding connecting body, wherein the metal shielding connecting body connects the major metal shielding wall and the minor metal shielding wall to form a metal shielding component, electrically connecting the major metal shielding wall and the minor metal shielding wall. The electrical connector insulation core comprises an electrical connector insulation core support structure, wherein the electrical connector insulation core assembles the major conductive terminal module connecting component, the minor conductive terminal module connecting component, and the metal shielding component. The electrical connector insulation core support structure provides support to the metal shielding component, enabling the major metal shielding wall to electrically connect the major conductive plastic bridging base, and enabling the minor metal shielding wall to electrically connect the minor conductive plastic bridging base, for transmitting shielding signals. Furthermore, the major metal shielding wall extends along the side of the major conductive terminal set, and the minor metal shielding wall extends along the side of the minor conductive terminal set, to respectively provide shielding for the major conductive terminal set and the minor conductive terminal set.

In addition, in the present application, the signal transmission element assembly may optionally include: a signal transmission extension material and an electrical connector. The electrical connector comprises: a major conductive terminal module, a minor conductive terminal module, a metal shielding module, and an electrical connector insulation core. The major conductive terminal module comprises a major conductive terminal set, a major conductive plastic bridging base, and a major insulation plastic connecting base, wherein the major conductive terminal set comprises a first major bridging conductive terminal, a second major bridging conductive terminal, and a major non-bridging conductive terminal. The major conductive plastic bridging base bridges across the major non-bridging conductive terminal and electrically connects the first major bridging conductive terminal and the second major bridging conductive terminal. The major insulation plastic connecting base joins the major conductive terminal set and the major conductive plastic bridging base to form a major conductive terminal module connecting component. The minor conductive terminal module comprises a minor conductive terminal set, a minor conductive plastic bridging base, and a minor insulation plastic connecting base, wherein the minor conductive terminal set comprises a first minor bridging conductive terminal, a second minor bridging conductive terminal, and a minor non-bridging conductive terminal. The minor conductive plastic bridging base bridges across the minor non-bridging conductive terminal and electrically connects the first minor bridging conductive terminal and the second minor bridging conductive terminal. The minor insulation plastic connecting base joins the minor conductive terminal set and the minor conductive plastic bridging base to form a minor conductive terminal module connecting component. The metal shielding module comprises a major metal shielding wall, a minor metal shielding wall, and a metal shielding connecting body, wherein the metal shielding connecting body connects the major metal shielding wall and the minor metal shielding wall to form a metal shielding component, electrically connecting the major metal shielding wall and the minor metal shielding wall. The electrical connector insulation core comprises an electrical connector insulation core support structure and an electrical connector insulation core joining port, wherein the electrical connector insulation core assembles the major conductive terminal module connecting component, the minor conductive terminal module connecting component, and the metal shielding component, such that the major conductive terminal set and the minor conductive terminal set respectively extend to the electrical connector insulation core joining port to facilitate joining with the signal transmission extension material for signal transmission. The electrical connector insulation core support structure provides support to the metal shielding component, enabling the major metal shielding wall to electrically connect the major conductive plastic bridging base, and enabling the minor metal shielding wall to electrically connect the minor conductive plastic bridging base, for transmitting shielding signals. Furthermore, the major metal shielding wall extends along the side of the major conductive terminal set, and the minor metal shielding wall extends along the side of the minor conductive terminal set, to respectively provide shielding for the major conductive terminal set and the minor conductive terminal set.

In summary, the signal transmission element assembly and electrical connector thereof provided in the present application are assembled at least from an electrical connector insulation core, a metal shielding wall, and multiple conductive terminal modules. The electrical connector insulation core provides support to the metal shielding wall, enabling the metal shielding wall to extend along the sides of the multiple conductive terminal modules to provide shielding for the multiple conductive terminal modules, thereby reducing the degree of interference experienced by the electrical connector during signal transmission and meeting the requirements of electronic devices for high-speed signal transmission. Additionally, the multiple conductive terminal modules allow for the respective adjustment of the number and structure of the conductive terminals. Therefore, even after the design of the electrical connector is completed, customized adjustments to the number and structure of the conductive terminals of the electrical connector can still be achieved by adjusting the assembled multiple conductive terminal modules, thereby meeting the requirements of electronic devices for signal transmission.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

1. An electrical connector comprising:
a major conductive terminal module comprising a major conductive terminal set, a major conductive plastic bridging base, and a major insulation plastic mating base, wherein, the major conductive terminal set comprises a first major bridging conductive terminal, a second major bridging conductive terminal, and a major non-bridging conductive terminal; the major conductive plastic bridging base is configured to span the major non-bridging conductive terminal and electrically connect the first major bridging conductive terminal and the second major bridging conductive terminal; and the major insulation plastic mating base is configured to mate with the major conductive terminal set and the major conductive plastic bridging base to form a major conductive terminal module mating component;
a minor conductive terminal module comprising a minor conductive terminal set, a minor conductive plastic bridging base, and a minor insulation plastic mating base, wherein, the minor conductive terminal set comprises a first minor bridging conductive terminal, a second minor bridging conductive terminal, and a minor non-bridging conductive terminal; the minor conductive plastic bridging base is configured to span the minor non-bridging conductive terminal and electrically connect the first minor bridging conductive terminal and the second minor bridging conductive terminal; and the minor insulation plastic mating base is configured to mate with the minor conductive terminal set and the minor conductive plastic bridging base to form a minor conductive terminal module mating component;
a metal shielding module comprising a major metal shielding wall, a minor metal shielding wall, and a metal shielding connecting body, wherein the metal shielding connecting body is configured to connect the major metal shielding wall and the minor metal shielding wall to form a metal shielding component in which the major metal shielding wall and the minor metal shielding wall are electrically connected; and
an electrical connector insulation core comprising an electrical connector insulation core support structure, wherein, the electrical connector insulation core is configured to assemble the major conductive terminal module mating component, the minor conductive terminal module mating component, and the metal shielding component together; the electrical connector insulation core support structure is configured to provide support for the metal shielding component to allow the major metal shielding wall and the minor metal shielding wall to be electrically connected to the major conductive plastic bridging base and the minor conductive plastic bridging base respectively so as to transmit shielding signals; and the major metal shielding wall is extended along the side of the major conductive terminal set to provide shielding for the major conductive terminal set, and the minor metal shielding wall is extended along the minor conductive terminal set to provide shielding for the minor conductive terminal set.

2. The electrical connector of claim 1, wherein the major conductive plastic bridging base comprises a first major conductive plastic bridging base clamping structure and a second major conductive plastic bridging base clamping structure, wherein the first major conductive plastic bridging base clamping structure is configured to clamp and position the first major bridging conductive terminal, and the second major conductive plastic bridging base clamping structure is configured to clamp and position the second major bridging conductive terminal; and the minor conductive plastic bridging base comprises a first minor conductive plastic bridging base clamping structure and a second minor conductive plastic bridging base clamping structure, wherein the first minor conductive plastic bridging base clamping structure is configured to clamp and position the first minor bridging conductive terminal, and the second minor conductive plastic bridging base clamping structure is configured to clamp and position the second minor bridging conductive terminal.

3. The electrical connector of claim 1, wherein the metal shielding component is a U-shaped structure disposed across the electrical connector insulation core support structure.

4. The electrical connector of claim 1, wherein the electrical connector insulation core is configured to assemble the major conductive terminal module mating component, the minor conductive terminal module mating component, and the metal shielding component in an assembling direction.

5. The electrical connector of claim 4, wherein the metal shielding component comprises a metal shielding component assembling channel and a metal shielding component assembling space, and the electrical connector insulation core support structure is allowed to enter the metal shielding component assembling space via the metal shielding component assembling channel in the assembling direction.

6. The electrical connector of claim 5, wherein the major metal shielding wall and the minor metal shielding wall are laterally positioned within the metal shielding component assembling space, and the electrical connector insulation core support structure provides lateral support for the major metal shielding wall and the minor metal shielding wall; and the metal shielding connecting body is longitudinally positioned within the metal shielding component assembling space, and the electrical connector insulation core support structure provides longitudinal support for the metal shielding connecting body.

7. The electrical connector of claim 1, wherein the major conductive plastic bridging base comprises a major conductive plastic bridging base abutting structure, wherein, in the major conductive terminal module mating component, the major conductive plastic bridging base abutting structure is exposed from the major insulation plastic mating base to abut the major metal shielding wall; and the minor conductive plastic bridging base comprises a minor conductive plastic bridging base abutting structure, wherein, in the minor conductive terminal module mating component, the minor conductive plastic bridging base abutting structure is exposed from the minor insulation plastic mating base to abut the minor metal shielding wall.

8. The electrical connector of claim 1, wherein the major metal shielding wall comprises a major metal shielding wall protrusion structure, and the major metal shielding wall protrusion structure is configured to abut the major conductive plastic bridging base; and the minor metal shielding wall comprises a minor metal shielding wall protrusion structure, and the minor metal shielding wall protrusion structure is configured to abut the minor conductive plastic bridging base.

9. A signal transmission element assembly comprising:
a signal transmission extension material; and
an electrical connector comprising:
a major conductive terminal module comprising a major conductive terminal set, a major conductive plastic bridging base, and a major insulation plastic connecting base, wherein, the major conductive terminal set comprises a first major bridging conductive terminal, a second major bridging conductive terminal, and a major non-bridging conductive terminal; the major conductive plastic bridging base is configured to span the major non-bridging conductive terminal and electrically connect the first major bridging conductive terminal and the second major bridging conductive terminal; and the major insulation plastic connecting base is configured to join the major conductive terminal set and the major conductive plastic bridging base to form a major conductive terminal module connecting component;
a minor conductive terminal module comprising a minor conductive terminal set, a minor conductive plastic bridging base, and a minor insulation plastic connecting base, wherein, the minor conductive terminal set comprises a first minor bridging conductive terminal, a second minor bridging conductive terminal, and a minor non-bridging conductive terminal; the minor conductive plastic bridging base is configured to span the minor non-bridging conductive terminal and electrically connect the first minor bridging conductive terminal and the second minor bridging conductive terminal; and the minor insulation plastic connecting base is configured to join the minor conductive terminal set and the minor conductive plastic bridging base to form a minor conductive terminal module connecting component;
a metal shielding module comprising a major metal shielding wall, a minor metal shielding wall, and a metal shielding connecting body, wherein the metal shielding connecting body is configured to join the major metal shielding wall and the minor metal shielding wall to form a metal shielding component in which the major metal shielding wall and the minor metal shielding wall are electrically connected; and
an electrical connector insulation core comprising an electrical connector insulation core support structure and an electrical connector insulation core joining port, wherein, the electrical connector insulation core is configured to assemble the major conductive terminal module connecting component, the minor conductive terminal module connecting component, and the metal shielding component together, so as to allow the major conductive terminal set and the minor conductive terminal set to respectively extend to the electrical connector insulation core joining port to be joined with the signal transmission extension material for signal transmission; the electrical connector insulation core support structure is configured to provide support for the metal shielding component to allow the major metal shielding wall and the minor metal shielding wall to be electrically connected to the major conductive plastic bridging base and the minor conductive plastic bridging base respectively so as to transmit shielding signals; and the major metal shielding wall is extended along the side of the major conductive terminal set, and the minor metal shielding wall is extended along the side of the minor conductive terminal set, so as to respectively provide shielding for the major conductive terminal set and the minor conductive terminal set.

10. The signal transmission element assembly of claim 9, wherein the signal transmission extension material is a circuit board material, a conductive wire material, or an inserting board material.
